(19) United States
(12) Patent Application Publication
(10) Pub. No.: US 2010/0116743 A1
(43) Pub. Date: May 13, 2010

(54) SILICA PARTICLES AND METHODS OF MAKING AND USING THE SAME

(76) Inventors: James Neil Pryor, West Friendship, MD (US); Lawrence Joseph Kindt, Sykesville, MD (US)

Correspondence Address: William D. Bunch;W. R. Grace & Co.-Conn, 7500 Grace Drive, Patent Department, Columbia, MD, 21044, US

(21) Appl. No.: 12/451,914

(22) PCT Filed: Jun. 4, 2008
(86) PCT No.: PCT/US2008/007034

§ 371 Date: Dec. 4, 2009

Related U.S. Application Data
(60) Provisional application No. 60/933,069, filed on Jun. 4, 2007.

(51) Int. Cl. B01D 15/08; B32B 1/00; C01B 33/12

(52) U.S. Cl. 210/656; 428/402; 423/336

(57) ABSTRACT

Silica particles and compositions containing silica particles are disclosed. Methods of making silica particles and methods of using silica particles are also disclosed.

### FIELD OF THE INVENTION

The present invention is directed to silica particles, compositions containing silica particles, methods of making silica particles, and methods of using silica particles.

### BACKGROUND OF THE INVENTION

In high pressure liquid chromatography (HPLC) columns, the packing media is subjected to a relatively high packing pressure so as to provide a dense separation media. For example, packing pressures up to or greater than 1500 psi are typical packing pressures. During exposure to such high packing pressures, a portion of the packing media, for example, silica particles, may break to form fines of particulate material. An increase in the amount of fines generated during a packing process can lead to a number of processing problems including, but not limited to, excess resistance to fluid flow through a column, non-uniform fluid flow through a column, and reduced column efficiency.

Efforts continue in the art to develop particles, such as silica particles, having an optimum Young's modulus so that the particles elastically yield only modestly during column packing. If the particle modulus is too low, excessive elastic particle deformation can result in processing problems such as those described above (e.g., high resistance to fluid flow. However, if the particle modulus is too high, a column of particles may lack adequate stability. Under use and with mechanical shock to the system, very high modulus particles may shift position resulting in degraded uniformity of fluid flow and reduced column efficiency.

There is a need in the art for silica particles having an optimum elastic modulus, which when used in a packed column, creates an “internal spring effect” within the column, namely, the silica particles have some degree of compression, but resist breakage when subjected to a packing pressure.

### SUMMARY OF THE INVENTION

The present invention addresses some of the difficulties and problems discussed above by the discovery of new silica particles. The silica particles have an optimum Young's modulus, which provides an “internal spring effect” within a column packed with the silica particles. The silica particles are believed to have an interior that is highly resistant to plastic deformation, and a surface having low resistance to elastic deformation (i.e., a low elastic modulus). The new silica particles are particularly suitable for use in a high pressure liquid chromatography (HPLC) column as chromatography media. The new silica particles are typically highly spherical, porous, essentially macro-void free, amorphous silica particles, and may be used as chromatographic media both without surface modification (i.e., unbonded or normal phase) or with surface modification (i.e., bonded or reverse phase, HIC, etc).

In one exemplary embodiment, the silica particles of the present invention comprise a porous silica particle comprising (i) an interior portion having a first elastic modulus, and (ii) a particle outer surface portion having a second elastic modulus, wherein the first elastic modulus is greater than the second elastic modulus. The difference is elastic modulus within a given silica particle may be the result of a varying pore density within regions of the silica particle. For example, an inner region of the silica particle may have a lower pore density than an outer surface region of the same silica particle.

In another exemplary embodiment, the silica particles of the present invention comprise a porous silica particle, wherein said particle possesses a plastic deformation of at least about 100 MPa and an elastic deformation of less than about 4 GPa. The high plastic deformation and low elastic deformation allow such silica particles, when utilized as chromatographic media, to be efficiently packed in chromatographic columns without damage to the particles.

The present invention is also directed to methods of making silica particles. In one exemplary method, the method of making silica particles comprises partially hydrolyzing an organosilicate so as to form a partially hydrolyzed material; distilling the partially hydrolyzed material to remove any ethyl alcohol and to form distilled partially hydrolyzed material; emulsifying the distilled partially hydrolyzed material in a polar continuous phase so as to form droplets of partially hydrolyzed silicates in the polar continuous phase; gelling the droplets via a condensation reaction with ammonium hydroxide so as to form spherical, porous particles; washing the spherical, porous particles; hydrothermally aging the spherical, porous particles; and drying the spherical, porous particles to form dried porous particles.

The present invention is further directed to methods of using silica particles. In one exemplary method of using silica particles, the method comprises a method of making a chromatography column comprising incorporating at least one porous silica particle into the chromatography column, the porous silica particle comprising (i) an interior portion having a first elastic modulus, and (ii) a particle outer surface portion having a second elastic modulus, wherein the first elastic modulus is greater than the second elastic modulus. Further exemplary methods of using silica particles may comprise using the above-described chromatography column to separate one or more materials from one another while passing through the chromatography column.

The present invention is even further directed to chromatography columns, methods of making chromatography columns, and methods of using chromatography columns, wherein the chromatography column comprises at least one porous silica particle, the at least one porous silica particle comprising (i) an interior portion having a first elastic modulus, and (ii) a particle outer surface portion having a second elastic modulus, wherein the first elastic modulus is greater than the second elastic modulus.

These and other features and advantages of the present invention will become apparent after a review of the following detailed description of the disclosed embodiments and the appended claims.

### BRIEF DESCRIPTION OF THE FIGURES

FIG. 1 depicts a magnified view of exemplary silica particles of the present invention;

FIG. 2A depicts a cross-sectional view of an exemplary silica particle of the present invention having a step-like property gradient;

FIG. 2B depicts a cross-sectional view of an exemplary silica particle of the present invention having a substantially continuous property gradient;

FIG. 3 depicts particle size analysis before and after packing exemplary silica particles of the present invention in a HPLC column;

FIG. 4 depicts scanning electron microscope (SEM) images of exemplary silica particles of the present invention after packing in a HPLC column;

FIG. 5 depicts column packing efficiency of exemplary silica particles of the present invention compared to conventional silica particles;

FIG. 6 depicts chromatographs showing peptide selectivity of exemplary silica particles of the present invention compared to conventional silica particles;

FIG. 7 depicts chromatographs showing pure synthetic peptide selectivity of exemplary silica particles of the present invention compared to conventional silica particles;

FIG. 8 depicts chromatographs showing crude synthetic peptide selectivity of exemplary silica particles of the present invention compared to conventional silica particles;

FIG. 9 depicts chromatographs of Crude 20-AA synthetic peptide using exemplary silica particles of the present invention and conventional silica particles;

FIG. 10 depicts chromatographs showing Vasoactive Intestinal Peptide (VIP) selectivity of exemplary silica particles of the present invention compared to conventional silica particles; and

FIG. 11 depicts insulin loading capacity of exemplary silica particles of the present invention compared to conventional silica particles.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to porous silica particles. The present invention is further directed to methods of making porous silica particles, as well as methods of using porous silica particles. A description of exemplary porous silica particles, methods of making porous silica particles, and methods of using porous silica particles are provided below.

### I. Silica Particles

The silica particles of the present invention have a physical structure and properties that enable the silica particles to provide one or more advantages when compared to known silica particles.

A. Silica Particle Physical Structure

The silica particles of the present invention have a spherical particle shape with an average largest particle dimension (i.e., a largest diameter dimension). Typically, the silica particles of the present invention have an average largest particle dimension of less than about 700 more typically, less than about 100 μm. In one desired embodiment of the present invention, the silica particles have an average largest particle dimension of from about 1.0 to about 100 μm, more desirably, from about 3.0 to about 20 μm.

The porous silica particles of the present invention typically have an aspect ratio of less than about 1.4 as measured, for example, using Transmission Electron Microscopy (TEM) techniques. As used herein, the term “aspect ratio” is used to describe the ratio between (i) the average largest particle dimension of the silica particles and (ii) the average largest cross-sectional particle dimension of the silica particles, wherein the cross-sectional particle dimension is substantially perpendicular to the largest particle dimension of the silica particle. In some embodiments of the present invention, the silica particles have an aspect ratio of less than about 1.3 (or less than about 1.2, or less than about 1.1, or less than about 1.05). Typically, the silica particles have an aspect ratio of from about 1.0 to about 1.2.

The porous silica particles of the present invention also have a pore volume that makes the silica particles desirable chromatography media. Typically, the silica particles have a pore volume as measured by nitrogen porosimetry of at least about 0.40 cc/g. In one exemplary embodiment of the present invention, the porous silica particles have a pore volume as measured by nitrogen porosimetry of from about 0.40 cc/g to about 1.4 cc/g. In another exemplary embodiment of the present invention, the porous silica particles have a pore volume as measured by nitrogen porosimetry of from about 0.75 cc/g to about 1.1 cc/g.

The porous silica particles of the present invention have an average pore diameter of at least about 40 Angstroms (Å). In one exemplary embodiment of the present invention, the silica particles have an average pore diameter from about 40 Å to about 700 Å. In a further exemplary embodiment of the present invention, the silica particles have an average pore diameter of from about 90 Å to about 150 Å.

The porous silica particles of the present invention also have a surface area as measured by the BET nitrogen adsorption method (i.e., the Brunauer Emmet Teller method) of at least about 150 m²/g. In one exemplary embodiment of the present invention, the silica particles have a BET surface area of from about 200 m²/g to about 450 m²/g. In a further exemplary embodiment of the present invention, the silica particles have a BET surface area of from about 260 m²/g to about 370 m²/g.

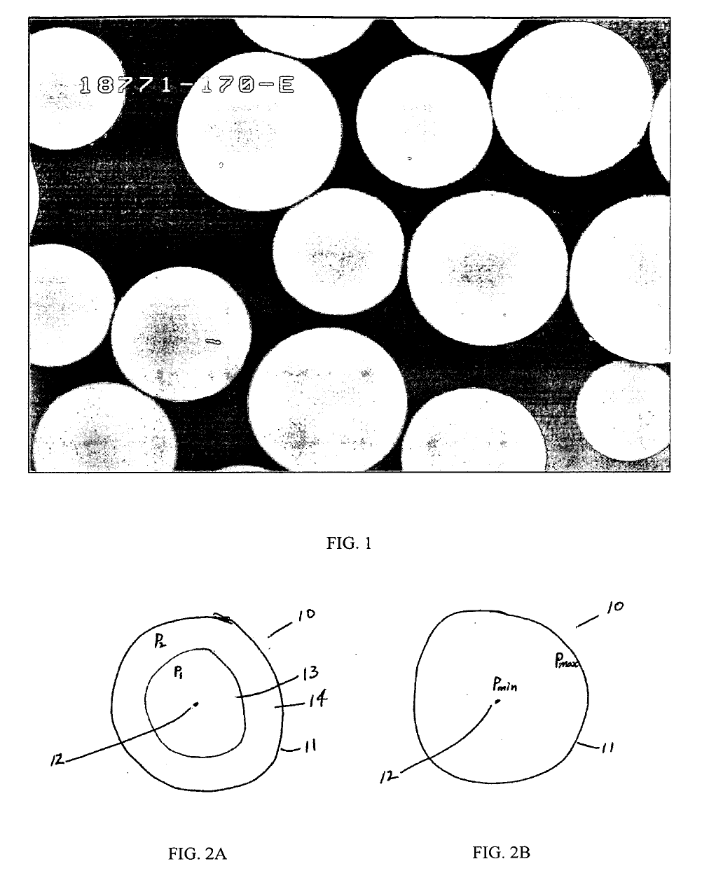

A magnified view of exemplary silica particles of the present invention is depicted in FIG. 1, as provided by a scanning electron microscope (SEM) at a magnification of 1,000. As shown in FIG. 1, exemplary silica particles 10 have a spherical shape and a relatively narrow particle size distribution. Further, as shown in FIGS. 2A and 2B, exemplary silica particles 10 are believed to have a particle property gradient along a cross-section of the particle.

As shown in FIG. 2A, in one embodiment of the present invention, exemplary silica particle 10 is believed to have a step-like property gradient between an interior 12 and an outer surface 11 of exemplary silica particle 10. For example, exemplary silica particle 10 may have a higher Young's modulus within an interior region 13 and a lower Young's modulus within a surface region 14. For example, exemplary silica particle 10 may have a higher Young's modulus (or a lower pore density) within an interior region 13 and a lower Young's modulus (or a higher pore density) within a surface region 14. It should be noted that in this embodiment, there may be more than two regions having different particle properties therein between interior 12 and outer surface 11 of exemplary silica particle 10.

As shown in FIG. 2B, in another embodiment of the present invention, exemplary silica particle 10 is believed to have a substantially continuous property gradient that changes from an interior value at interior 12 to a surface value along outer surface 11. For example, exemplary silica particle 10 may have a maximum Young's modulus (or a minimum pore density, Pₘᵢₙ) at interior 12 and a minimum Young's modulus (or a maximum pore density, Pₘₐₓ) along outer surface 11. It should be noted that in this embodiment, a maximum or minimum property value (e.g., minimum pore density, Pₘᵢₙ) may be present at some point between interior 12 and outer surface 11 of exemplary silica particle 10, instead of at interior 12 as shown in FIG. 2B.

B. Properties of the Silica Particles

As a result of the above-described physical properties of the silica particles of the present invention, the silica particles are well suited for use as chromatography media in HPLC applications. The substantially spherical shape allows uniform packing and thus more uniform flow of liquid through an HPLC column, which result in better column efficiency. Further, due to the plastic deformation properties of the silica particles, the silica particles of the present invention resist breaking, when exposed to packing pressures, so as to prevent excess resistance to fluid flow and so as to maintain uniform fluid flow through an HPLC column.

As discussed above, the silica particles of the present invention appear to have an optimum Young's modulus that enables the particles to elastically yield modestly during column packing, but not enough to cause breakage of the particles. The silica particles of the present invention, when used in an HPLC column, provide an “internal spring effect,” which stabilizes the column in a manner similar to that achieved by dynamic axial compression.

Further, as discussed above, it is believed that the silica particles of the present invention possess a radially-extending property gradient in elastic modulus. More specifically, it is believed that the silica particles of the present invention have a surface region with a suitably lower modulus than an interior region of the silica particles. Such a particle configuration would explain why the silica particles of the present invention form such a stabilized packed column (i.e., low particle movement and void formation in the column). It is believed that the silica particles of the present invention possess greater elastic deformation at the surface of the particles, but a higher modulus toward the interior of the particles such that the interior modulus prevents the particle from gross particle (i.e., plastic) deformation that can lead to particle breakage and high resistance to fluid flow.

In addition, due to the believed porosity gradient of the silica particles of the present invention, the silica particles provide good mass transfer properties when utilized in a packed column. Because in chromatographic separations, most of the molecules do not diffuse to the very center of the particle, the previously described radially-extending porosity gradient allows for increased mass transfer in and out of the particles so as to yield improved column efficiency.

In one embodiment, the particles of the present invention possess a hardness or plastic deformation as measured by atomic force microscopy (AFM) of at least about 100 MPa, typically at least about 200 MPa, more typically at least about 300 MPa, and even more typically at least about 400 MPa. AFM is performed using a Nanoman II SPM System available from Veeco Instruments with a diamond tipped probe at a force of 30 Hardness is determined by the formula Hardness=Force/Area, where the area is the size of the indentation formed by the probe. AFM is performed as described in “Theoretical Modelling And Implementation Of Elastic Modulus Measurement At The Nanoscale Using Atomic Force Microscope,” Journal of Physics: Conference Series 61, pp 1303-07, 2007.

In another embodiment, the particles of the present invention possess a Young's modulus or elastic deformation as measured by AFM of less than about 4 GPa, typically less than about 3 GPa, more typically less than about 2 GPa, and even more typically less than about 1 GPa. AFM is performed using a Nanoman II SPM System available from Veeco Instruments with a diamond tipped probe at a force of 3.297 μN. Young's modulus is determined by Oliver and Pharr analysis as described in “An Improved Technique for Determining Hardness and Elastic Modulus Using Load and Displacement Sensing Indentation Experiments,” J. Mater. Res., Vol. 7, pp 1564-83, 1992.

In another exemplary embodiment, the silica particles of the present invention comprise a porous silica particle, wherein said particle possesses a plastic deformation of at least about 100 MPa and an elastic deformation of less than about 4 GPa, preferably a plastic deformation of at least about 100 MPa and an elastic deformation of less than about 3 GPa, and even more preferably a plastic deformation of at least about 100 MPa and an elastic deformation of less than about 2 GPa. Moreover, the silica particles of the present invention may possess any combination of plastic deformation and elastic deformation properties recited herein, such as for example a plastic deformation of at least about 100 MPa (or 200 MPa, 300 MPa, or 400 MPa, etc.) and an elastic deformation of less than about 4 GPa (or 3 GPa, or 2 GPa, or 1 GPa, etc.). The high plastic deformation and low elastic deformation allow such silica particles, when utilized as chromatographic media, to be efficiently packed in chromatographic columns without damage to the particles.

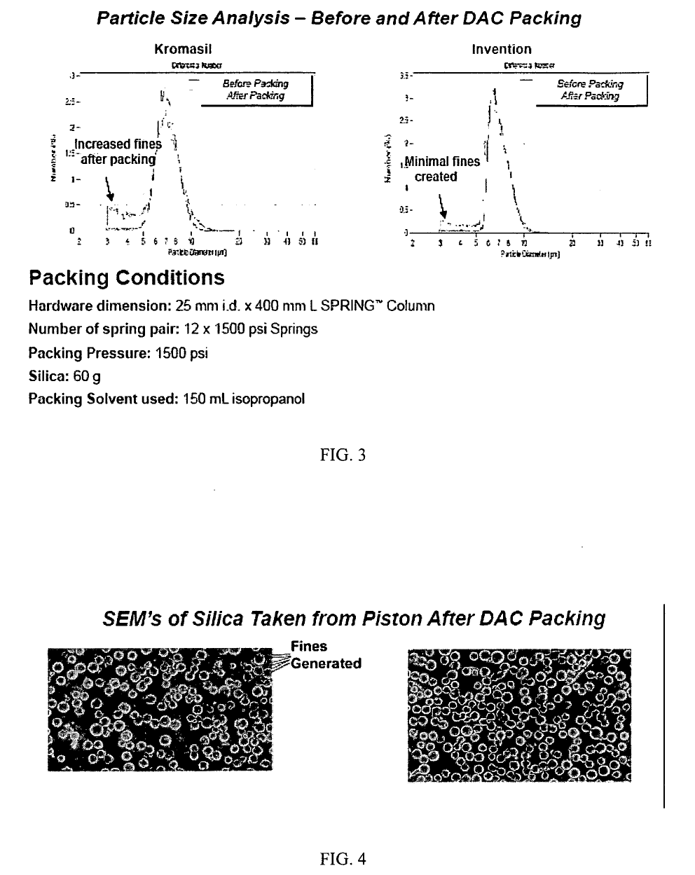

The above-mentioned properties of the disclosed silica particles are further detailed with reference to FIGS. 3-5. FIG. 3 depicts particle size analysis before and after packing exemplary silica particles of the present invention in a HPLC column. As shown in FIG. 3, silica particles of the present invention exhibit less particle breakage during dynamic axial compression packing as depicted by

(1) the closeness of the “before” and “after” Number (%) lines for the silica particles of the present invention in comparison to the “before” and “after” Number (%) lines for a commercially available silica particle, Kromasil® 10 micron C18 available from Eka Nobel AB; and
(2) the minimal amount of fines created for the silica particles of the present invention in comparison to the increased amount of fines for the commercially available silica particle. After packing the particles of the present invention in the column, the particle size distribution is not substantially changed, whereas the particle size distribution of commercially available media is significantly different. For example, minimal fines are created (e.g., less than about 50% by number based on the total number of fines<5 μm) with the particles of the present invention, whereas much more fines are created (e.g., greater than 50% by number based on the total number of fines<5 μm) with commercially available particles. Preferably, less than about 40% fines by number are created during packing of the particles of the present invention, and more preferably less than about 30%, and even more preferably less than about 20% (i.e., less than 15%, 10%, 5%, 4%, 3%, 2%, etc.).

FIG. 4 depicts scanning electron microscope (SEM) images (magnification=500) of exemplary silica particles of the present invention after dynamic axial compression packing in a HPLC column (right-hand image) versus a SEM image of the commercially available silica particle mentioned above after dynamic axial compression packing in a HPLC column (left-hand image). The left-hand image shows fines generated during dynamic axial compression packing of the commercially available silica particle mentioned above, while the right-hand image is essentially free from fines generated during dynamic axial compression packing of the silica particles of the present invention.

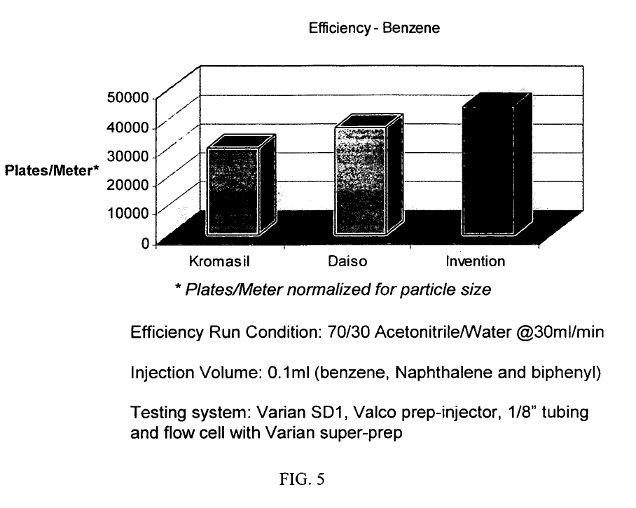

FIG. 5 depicts column packing efficiency of exemplary silica particles of the present invention compared to conventional silica particles. As shown in FIG. 5, the silica particles of the present invention exhibited the highest number of plates/meter compared to commercially available silica particles, Kromasil 10 micron C18 available from Eka Nobel, AB and Daiso 10 micron C18 available from Daiso Co. Ltd.

### II. Methods of Making Silica Particles

The present invention is also directed to methods of making silica particles. Raw materials used to form the silica particles of the present invention, as well as method steps for forming the silica particles of the present invention are discussed below.

A. Raw Materials

The methods of making silica particles of the present invention may be formed from a number of silicon-containing raw materials. Suitable silicon-containing raw materials include, but are not limited to, tetraethyl orthosilicate (TEOS) commercially available from a number of sources including Sigma-Aldrich Co. (St. Louis, Mo.); partially oligomerized silicates such as SILBOND™ 40 or SILBOND™ 50 commercially available from Silbond Corporation (Weston, Mich.); partially oligomerized silicates such as DYNASIL™ 40 commercially available from Dynasil Corporation (West Berlin, N.J.); and partially oligomerized silicates such as TES 40 WN commercially available from Wacker Chemie AG (Munich, Germany).

In one desired embodiment, SILBOND™ 40 is utilized to form a “small molecule” product. As used herein, the term “small molecule” product is used to describe silica particles of the present invention that are particular useful in small-molecule chromatography applications. “Small molecule” silica particles of the present invention typically have a N₂ pore volume ranging from about 0.75 to about 1.1 cc/g; a N₂ surface area ranging from about 260 to about 370 m²/g; and an average pore diameter ranging from about 90 to about 150 Angstroms (Å).

B. Process Steps

The silica particles of the present invention are typically prepared using a multi-step process, wherein an organosilicate, such as those described above, is partially hydrolyzed, distilled, and then dispersed into a more polar continuous phase resulting in the formation of small droplets due to the immiscibility of the partially hydrolyzed silicates in the polar continuous phase. These droplets are then gelled as a result of condensation reactions catalyzed by ammonium hydroxide. The resulting spherical, porous particles are then washed, hydrothermally aged and dried. It has been discovered that process conditions during the hydrothermally aging and drying steps are of particular importance in controlling the pore structure of the resulting particles. The resulting porous silica particles can then be sized to an appropriately narrow particle size distribution by conventional means (e.g., elutriation or air classification). A further description of the various process steps is provided below.

1. Partial Hydrolyzing Step

The degree of hydrolysis is an important process parameter for obtaining silica particles having desired physical properties (e.g., an optimum Young's modulus, particle size, etc.). For example, over-hydrolysis may result in a solution that is completely miscible in the continuous phase of the particle formation step, while under-hydrolysis may result in material that is too unreactive during the subsequent condensation (i.e., gelation) step.

Partial hydrolysis is typically performed using 0.1 M HCl (aqueous) although other acids could be used as well. Ethyl alcohol (EtOH) is added to this mixture (with stirring) to overcome the immiscibility between the organosilicate and the aqueous phases. The reaction proceeds spontaneously at ambient temperature. One typical combination of reactants comprises 100.0 g of SILBOND™ 40, 21.5 g of EtOH, and 4.6 g of 0.1 M HCl (aqueous).

2. Distillation Step

Distillation of the partially hydrolyzed material (PHS) may be conducted to remove EtOH (i.e., both that which was added and that which was formed as a by-product during the hydrolysis step). The distillation step is minimizes and/or eliminates the formation of macro-void free particles. As used herein, the term “macro-void free particles” refers to silica particles having a substantially continuous microporous particle structure. The distillation is typically performed under vacuum (i.e., less than 100 Ton) at about 90° C. for a period of time necessary to remove EtOH (typically, less than about 1 hour).

3. Particle Formation (Emulsification) Step

Particle formation is accomplished by emulsification of the PHS into an ammoniated aqueous phase. The resulting small droplets quickly gel (i.e., solidify) due to ammonia catalyzed condensation reactions involving the PHS.

Two methods have been employed to produce silica particles in the 1 to 100 μm particle size range. The first method is a batch technique using a Cowles mixer in two steps. In the first step, namely, the droplet formation step, the distilled, PHS is emulsified in an isopropyl alcohol (IPA)/water solution (e.g., a 30 wt % IPA aqueous solution). Then, NH₄OH is added in a second step, with continuous mixing, to drive the condensation reaction so as to result in solidification of the porous, spherical particles. Mean particle size is controlled by mixing blade tip speed (e.g., higher speed produces smaller particles) and continuous phase composition (e.g., more alcohol produces smaller particles).

A second method to produce silica particles utilizes an in-line static mixer to emulsify the PHS into a 30 wt % IPA/1 wt % NH₄OH aqueous solution. In this case, higher velocity through the in-line mixer results in a smaller particle size.

4. Filtering/Decanting Step

Following the particle formation step, filtering and decanting is typically employed to remove excess alcohol, as well as any ammonia from the silica product. In a typical filtering/decanting step, a filter cake resulting from the above-described particle formation step is re-suspended in deionized H₂O (e.g., 12 liters of deionized H₂O), and then left to settle overnight (e.g., 12 hours). Following the settling period, the particle-containing solution is decanted to remove most of the liquid.

5. Hydrothermal Aging Step

A hydrothermal aging step can be used to decrease the internal surface area of the porous silica particles. In a manner similar to silica gel manufacture, more severe aging (i.e., longer, hotter, and/or more alkaline) results in more surface area reduction and greater retention of particle porosity (pore volume) during drying. At the end of the aging step, sufficient deionized water is added to cool and thus quench the aging process.

In one exemplary embodiment, the hydrothermal aging step comprises re-suspending the settled silica cake formed in the above-described decanting/filtering step in a sufficient amount of deionized water to make a stirrable slurry (e.g., about 1 kg dry basis of silica cake in about 1 liter of added water). The stirred slurry is then heated to about 75° C. for about 90 minutes. The aging is stopped with the addition of about 12 liters of ambient temperature deionized water (per liter of heated water). The suspension is then either filtered or left to settle and decanted.

6. Drying Step

Drying rate also has an effect on the surface area and pore volume of the final silica product. In one exemplary embodiment, the drying step comprises spreading a decanted volume or filter cake of silica product into a tray so as to form a silica cake thickness of about 1.25 cm; placing the tray containing the silica cake in a gravity convection oven for about 20 hours at an oven temperature of about 140° C.; removing the tray and silica from the oven; and collecting the silica. The dried silica material is then ready for subsequent optional sizing and bonding steps.

### III. Methods of Using Silica Particles

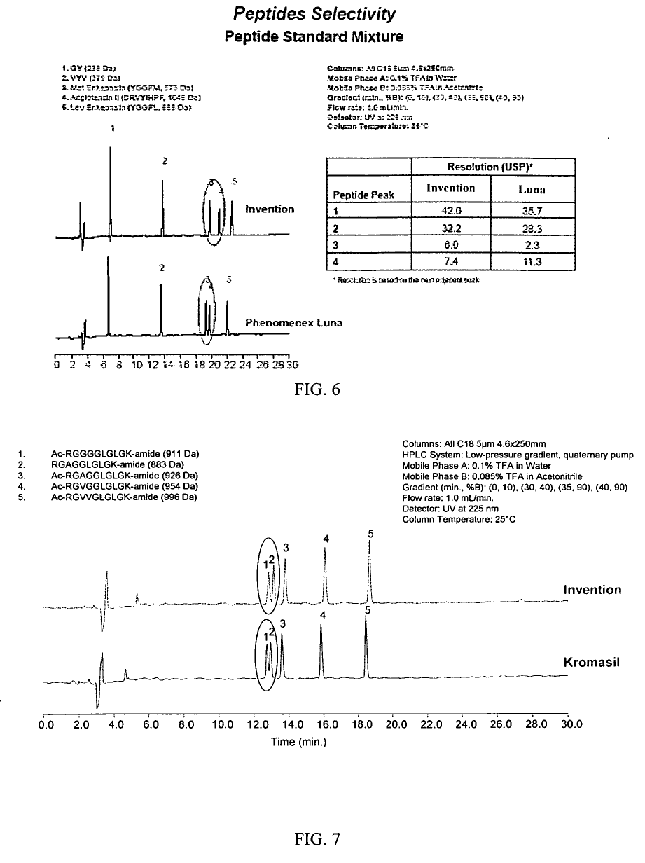

The present invention is further directed to methods of using silica particles. As discussed above, the silica particles may be used as chromatographic media. A variety of methods of using silica particles as chromatographic media are depicted in FIGS. 6-11.

FIG. 6 depicts chromatographs showing peptide selectivity of exemplary silica particles of the present invention compared to conventional silica particles, Luna® 5 micron C18 available from Phenomenex Inc.

FIG. 7 depicts chromatographs showing pure synthetic peptide selectivity of exemplary silica particles of the present invention compared to conventional silica particles, Kromasil 5 micron C18 available from Akzo Nobel AB.

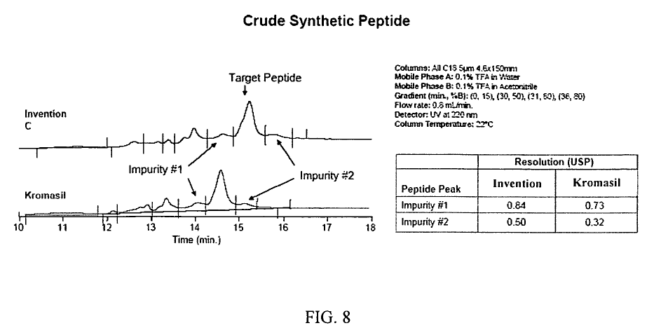

FIG. 8 depicts chromatographs showing crude synthetic peptide selectivity of exemplary silica particles of the present invention compared to conventional silica particles, Kromasil 5 micron C18 available from Akzo Nobel AB.

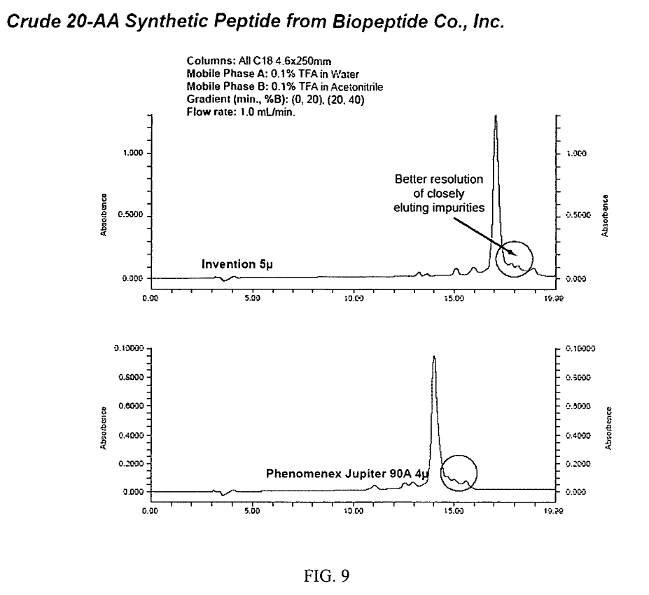

FIG. 9 depicts chromatographs of Crude 20-AA synthetic peptide using exemplary silica particles of the present invention and conventional silica particles, Jupiter® Proteo 5 micron C18 available from Phenomenex Inc.

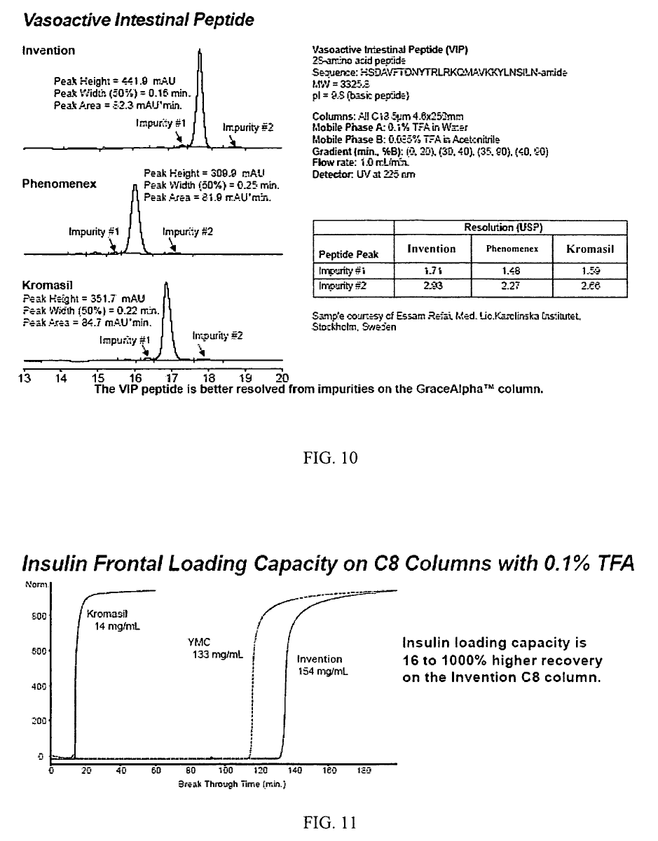

FIG. 10 depicts chromatographs showing Vasoactive Intestinal Peptide (VIP) selectivity of exemplary silica particles of the present invention compared to conventional silica particles.

FIG. 11 depicts insulin loading capacity of exemplary silica particles of the present invention compared to conventional silica particles, Kromasil 5 micron C8 available from Akzo Nobel AB and Hydrosphere 5 micron C8 available from YMC Co., Ltd.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of A Partially Hydrolyzed Material (PHS)

230 g of a 0.1 M HCl (aqueous) solution is added to 5,000 g of SILBOND™ 40 while stirring. Then, 1075 g of EtOH is added to this mixture while stirring to overcome the immiscibility between the SILBOND™ 40 and the aqueous phase. The reaction proceeded spontaneously at ambient temperature.

The resulting partially hydrolyzed material (PHS) is distilled to remove any EtOH added to the mixture or formed as a by-product during the hydrolysis step. The distillation is performed under vacuum (<100 Torr) at 90° C.

### Example 2

### Preparation of “Small Molecule” Silica Particles Using Batch Mixing

3,800 g of the distilled PHS formed in Example 1 is poured into 14,900 g of 30 wt % IPA/water (previously prepared and allowed to sit for at least 16 hours to allow for degassing). A Cowles mixer is started and set to 1160 rpm for 5 minutes to complete the emulsification. Then, 378 g of 30 wt % NH₄OH is added (all at once) while the mixing is continued. The solution is mixed at 1160 rpm for an additional 20 minutes during which particle gelation is completed. The silica suspension is left to settle overnight.

On the next day, the silica suspension is filtered and the resulting silica cake is re-suspended with 12 liters of deionized H₂O to remove any excess alcohol and/or ammonia. The silica solution is left to settle overnight and decanted the next day. This procedure is repeated once again.

The silica cake from the decanted solution is re-suspended in about 1 liter of deionized water to make a stirrable slurry. The stirred slurry is then heated to 75° C. for 90 minutes. The aging is stopped with the addition of about 12 liters of ambient temperature deionized water. The suspension is then filtered to remove excess fluid.

The silica cake product is spread into a tray and leveled to a thickness of about 1.25 cm. The tray containing the silica cake is placed in a 140° C. gravity convection oven for 20 hours. The tray and silica were then removed from the oven and the silica is bottled.

### Example 3

### Preparation of “Small Molecule” Silica Particles Using an In-Line Static Mixer

The distilled PHS formed in Example 1 (950 ml/min) and 30% IPA/1% NH₄OH aqueous solution (4,090 ml/min) are mixed through 15.2 cm (6 in.) diameter static mixers. The resulting slurry of silica particles then flowed into a container that is agitated. The silica suspension is left to settle overnight.

On the next day, the silica suspension is filtered and the resulting silica cake is re-suspended with 12 liters of deionized H₂O to remove any excess alcohol and/or ammonia. The silica solution is left to settle overnight and decanted the next day. This procedure is repeated once again.

The silica cake from the decanted solution is re-suspended in about 1 liter of deionized water to make a stirrable slurry. The stirred slurry is then heated to 75° C. for 90 minutes. The aging is stopped with the addition of about 12 liters of ambient temperature deionized water. The suspension is then filtered to remove excess fluid.

The silica cake product is spread into a tray and leveled to a thickness of about 1.25 cm. The tray containing the silica cake is placed in a 140° C. gravity convection oven for 20 hours. The tray and silica are then removed from the oven and the silica is bottled.

### Example 4

### Testing of Silica Particles by AFM

In this Example, the silica particles of the present invention comprised of spherical porous particles of 10 μm are tested by AFM to determine elastic and plastic deformation properties. The silica includes a surface treatment that yields a layer C₁₈ silane covalently bonded to the silica surface, which renders the particles hydrophobic. The elastic and plastic deformation properties are compared to commercially available silica particles, Daiso SP-120-ODS, having spherical porous silica particles of 10 μm with a layer C₁₈ silane covalently bonded to the silica surface, which is commercially available from Daiso Co., Ltd. The elastic and plastic deformation properties of each silica particle are measured as described in “Theoretical Modelling And Implementation Of Elastic Modulus Measurement At The Nanoscale Using Atomic Force Microscope,” Journal of Physics: Conference Series 61, pp 1303-07, 2007. For plastic deformation, AFM is performed using a Nanoman II SPM System available from Veeco Instruments with a diamond tipped probe at a force of 30 μN. Hardness is determined by the formula Hardness=Force/Area, where the area is the size of the indentation formed by the probe. For elastic deformation, AFM is performed using a Nanoman II SPM System available from Veeco Instruments with a diamond tipped probe at a force of 3.297 μN. Young's modulus is determined by Oliver and Pharr analysis as described in “An Improved Technique for Determining Hardness and Elastic Modulus Using Load and Displacement Sensing Indentation Experiments,” J. Mater. Res., Vol. 7, pp 1564-83, 1992. As can be seen in Table 1, the plastic deformation of the silica particles of the present invention is much higher than that of conventional or commercially available silicas and the elastic deformation of the silica particles of the present invention is much lower than that of conventional silicas.

TABLE 1

| | | |
|---|---|---|
| | Invention | Daiso Silica |
| Deformation | Silica Particle | Particle |

| | | | | |
|---|---|---|---|---|
| Plastic | 420 | MPa | 78 | MPa |
| Elastic | 0.539 | GPa | 4.7 | GPa |

### Example 5

### Packing of Silica Particles in Chromatography Columns

In this Example, the silica particles of the present invention comprised of spherical porous particles of 10 μm are tested in a chromatographic column to determine the media packing efficiency. The silica includes a surface treatment that yields a layer C₁₈ silane covalently bonded to the silica surface, which renders the particles hydrophobic. The peptide resolution of this media is compared to that of other medias, including Kromasil®, having spherical porous silica particles of 10 μm with a layer C₁₈ silane covalently bonded to the silica surface, which is commercially available from Akzo Nobel AB, and Daiso SP-120-ODS, having spherical porous silica particles of 10 μm with a layer C₁₈ silane covalently bonded to the silica surface, which is commercially available from Daiso Co., Ltd. The media is packed into 25 mm×400 mm Spring™ columns available from Alltech Associates, Inc. The media is packed into the columns at 1500 psi using 150 ml of isopropanol per 60 g of media. The final column bed length is 250 mm. As can be seen in FIG. 3, the number of small particles, or fines, that are generated after packing is much lower than that of the conventional silicas. For example, after packing the invention has less than half the amount of fines (less than 5 μm particle size) as Kromasil.

Reversed-phase chromatography is utilized as the separation technique for evaluating the efficiency of each column. A mixture of benzene, naphthalene and biphenyl is injected into each column under isocratic conditions using a mobile phase comprised of 70% acetonitrile and 30% water by volume. The flow rate is 10 ml/minute. The column is run at a room temperature of 25° C. The detection is performed using a Super Prep flow cell and Rainin detector (available from Varian, Inc.) at 254 nm. A Varian SD-1 preparative pump (available from Varian, Inc.) a Valco prep manual Injector (available from Valco Instruments Company Inc.), and EZ Chrom™ (available from Scientific Software, Inc.), are also utilized in the analyses.

The results are shown in FIG. 5, which demonstrate the increased column efficiency using the silica particles of the present invention over that of conventional media.

### Example 6

### Use of Silica Particles as Chromatography Media

In this Example, the silica particles of the present invention comprised of spherical porous particles of 5 μm is tested in a chromatographic column to determine its ability to separate various biological substances, such as peptides. The silica includes a surface treatment that yields a layer C₁₈ silane covalently bonded to the silica surface, which renders the particles hydrophobic. The peptide resolution of this media is compared to that of another media, under the trade name Luna™, having spherical porous silica particles of 5 μm with a layer C₁₈ silane covalently bonded to the silica surface, which is commercially available from Phenomenex, Inc.

Reversed-phase chromatography is utilized as the separation technique for each column. A mixture of peptides, (GY (238 Da), VYV (379 Da), Met Enkephalin (YGGFM, 573 Da), Anglotensin II (DRVYIHPF, 1045 Da) and Leu Enkephalin (YGGFL, 555 Da)) listed in TABLE 1, is injected into each column (4.6 mm×250 mm) under the following conditions: a mobile phase including solvent A comprising 0.1% v/v TFA in water; and solvent B comprising 0.085% v/v TFA in acetonitrile. A gradient process is used wherein the column is equilibrated at 10% solvent B and 90% solvent A for 30 minutes; followed by increasing from 10% up to 40% solvent B (60% solvent A); holding the flow of solvent B at 40% for 5 minutes; followed by increasing from 40% up to 90% solvent B (10% solvent A); and holding the flow of solvent B at 90% for 5 minutes. The flow rate is 1.0 ml/minute. The column is run at a room temperature of 25° C. The detection is performed using a UVD 170S detector (available from Dionex Corp., Sunnyvale, Calif.) at 225 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The results are shown in FIG. 6 and TABLE 2, which demonstrate the increased resolution of each peptide peak using the silica particles of the present invention over that of conventional media.

TABLE 2

| | Invention Media | Phenomenex Luna |
|---|---|---|
| Peptide Peak | Resolution* | Media Resolution* |
| 1 | 42.0 | 35.7 |
| 2 | 32.2 | 28.3 |
| 3 | 6.0 | 2.3 |
| 4 | 7.4 | 11.3 |

*Resolution is based on the next adjacent peak.

### Example 7

### Use of Silica Particles as Chromatography Media

In this Example, the silica particles of the present invention comprised of spherical porous particles of 5 μm is tested in a chromatographic column to determine its ability to separate various biological substances, such as peptides. The silica includes a surface treatment that yields a layer C₁₈ silane covalently bonded to the silica surface, which renders the particles hydrophobic. The peptide resolution of this media is compared to that of another media, under the trade name Kromasil®, having spherical porous silica particles of 5 μm with a layer C₁₈ silane covalently bonded to the silica surface, which is commercially available from Akzo Nobel AB.

Reversed-phase chromatography is utilized as the separation technique for each column. A mixture of peptides, (Ac-RGGGGLGLGK-amide (911 Da), RGAGGLGLGK-amide (883 Da), Ac-RGAGGLGLGK-amide (926 Da), Ac-RGVGGLGLGK-amide (954 Da) and Ac-RGVVGLGLGK-amide (996 Da)), is injected into each column (4.6 mm×250 mm) under the following conditions: a mobile phase including solvent A comprising 0.1% v/v TFA in water; and solvent B comprising 0.085% v/v TFA in acetonitrile. A gradient process is used wherein the column is equilibrated at 10% solvent B and 90% solvent A for 30 minutes; followed by increasing from 10% up to 40% solvent B (60% solvent A); holding the flow of solvent B at 40% for 5 minutes; followed by increasing from 40% up to 90% solvent B (10% solvent A); and holding the flow of solvent B at 90% for 5 minutes. The flow rate is 1.0 ml/minute. The column is run at a room temperature of 25° C. The detection is performed using a UVD 170S detector (available from Dionex Corp., Sunnyvale, Calif,) at 225 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The results are shown in FIG. 7, which demonstrate the increased resolution of each peptide peak using the silica particles of the present invention over that of conventional media.

### Example 8

### Use of Silica Particles as Chromatography Media

In this Example, the silica particles of the present invention comprised of spherical porous particles of 5 μm is tested in a chromatographic column to determine its ability to separate a target biological substance, such as a peptide, from impurities. The silica includes a surface treatment that yields a layer C₁₈ silane covalently bonded to the silica surface, which renders the particles hydrophobic. The peptide resolution of this media is compared to that of another media, under the trade name Kromasil®, having spherical porous silica particles of 5 μm with a layer C₁₈ silane covalently bonded to the silica surface, which is commercially available from Akzo Nobel AB.

Reversed-phase chromatography is utilized as the separation technique for each column. A mixture of a crude synthetic peptide, available from Bachem, Inc., and two impurities is injected into each column (4.6 mm×150 mm) under the following conditions: a mobile phase including solvent A comprising 0.1% v/v TFA in water; and solvent B comprising 0.1% v/v TFA in acetonitrile. A gradient process is used wherein the column is equilibrated at 15% solvent B and 85% solvent A for 30 minutes; followed by increasing from 15% up to 50% solvent B (50% solvent A); holding the flow of solvent B at 50% for 1 minute; followed by increasing from 50% up to 80% solvent B (20% solvent A); and holding the flow of solvent B at 80% for 5 minutes. The flow rate is 0.8 ml/minute. The column is run at a room temperature of 22° C. The detection is performed using a UVD 170S detector (available from Dionex Corp., Sunnyvale, Calif.) at 220 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The results are shown in FIG. 8 and TABLE 3, which demonstrate the increased resolution of the peptide peak from closely eluted impurities using the silica particles of the present invention over that of conventional media.

TABLE 3

| | Invention Media | Kromasil Media |
|---|---|---|
| Peptide Peak | Resolution | Resolution |
| Impurity #1 | 0.84 | 0.73 |
| Impurity #2 | 0.50 | 0.32 |

### Example 9

### Use of Silica Particles as Chromatography Media

In this Example, the silica particles of the present invention comprised of spherical porous particles of 5 μm is tested in a chromatographic column to determine its ability to separate a target biological substance, such as a peptide, from impurities. The silica includes a surface treatment that yields a layer C₁₈ silane covalently bonded to the silica surface, which renders the particles hydrophobic. The peptide resolution of this media is compared to that of another media, under the trade name Jupiter®, having spherical porous silica particles of 4 μm with a layer C₁₈ silane covalently bonded to the silica surface, which is commercially available from Phenomenex, Inc.

Reversed-phase chromatography is utilized as the separation technique for each column. A mixture of a crude synthetic peptide available from Biopeptide Co., Inc., is injected into each column (4.6 mm×250 mm) under the following conditions: a mobile phase including solvent A comprising 0.1% v/v TFA in water; and solvent B comprising 0.1% v/v TFA in acetonitrile. A gradient process is used wherein the column is equilibrated at 20% solvent B and 80% solvent A for 20 minutes; followed by increasing from 20% up to 40% solvent B (60% solvent A). The flow rate is 1.0 ml/minute. The column is run at a room temperature of 25° C. The detection is performed using a UVD 170S detector (available from Dionex Corp., Sunnyvale, Calif.) at 220 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The results are shown in FIG. 9, which demonstrate the increased resolution of the peptide peak from closely eluted impurities using the silica particles of the present invention over that of conventional media.

### Example 10

### Use of Silica Particles as Chromatography Media

In this Example, the silica particles of the present invention comprised of spherical porous particles of 5 μm is tested in a chromatographic column to determine its ability to separate a target biological substance, such as a peptide, from impurities. The silica includes a surface treatment that yields a layer C₁₈ silane covalently bonded to the silica surface, which renders the particles hydrophobic. The peptide resolution of this media is compared to that of other medias, including Kromasil®, having spherical porous silica particles of 5 μm with a layer C₁₈ silane covalently bonded to the silica surface, which is commercially available from Akzo Nobel AB, and Luna®, having spherical porous silica particles of 5 μm with a layer C₁₈ silane covalently bonded to the silica surface, which is commercially available from Phenomenex, Inc.

Reversed-phase chromatography is utilized as the separation technique for each column. A mixture of a vasoactive intestinal peptide (28-amino acid peptide, HSDAVFTDNYTRLRKQMAVKKYLNSILN-amide, MW 3325.8), available from Karolinska Institutet, Stockholm, Sweden, and two impurities is injected into each column (4.6 mm×250 mm) under the following conditions: a mobile phase including solvent A comprising 0.1% v/v TFA in water; and solvent B comprising 0.085% v/v TFA in acetonitrile. A gradient process is used wherein the column is equilibrated at 20% solvent B and 80% solvent A for 30 minutes; followed by increasing from 20% up to 40% solvent B (60% solvent A); holding the flow of solvent B at 40% for 5 minutes; followed by increasing from 40% up to 90% solvent B (10% solvent A); and holding the flow of solvent B at 90% for 5 minutes. The flow rate is 1.0 ml/minute. The column is run at a room temperature of 25° C. The detection is performed using a UVD 170S detector (available from Dionex Corp., Sunnyvale, Calif.) at 225 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The results are shown in FIG. 10 and TABLE 4, which demonstrate the increased resolution of the peptide peak from closely eluted impurities using the silica particles of the present invention over that of conventional media.

TABLE 4

| | Invention Media | Kromasil Media | Phenomenex Luna |
|---|---|---|---|
| Peptide Peak | Resolution | Resolution | Media Resolution |
| Impurity #1 | 1.71 | 1.59 | 1.48 |
| Impurity #2 | 2.93 | 2.66 | 2.27 |

### Example 11

### Use of Silica Particles as Chromatography Media

In this Example, the silica particles of the present invention comprised of spherical porous particles of 5 μm are tested in a chromatographic column to determine the column's insulin frontal loading capacity. The silica includes a surface treatment that yields a layer C₈ silane covalently bonded to the silica surface, which renders the particles hydrophobic. The insulin loading capacity of this media is compared to that of other medias, including Kromasil®, having spherical porous silica particles of 5 μm with a layer C₈ silane covalently bonded to the silica surface, which is commercially available from Akzo Nobel AB and Hydrosphere, having spherical porous silica particles of 5 μm with a layer C₈ silane covalently bonded to the silica surface, which is commercially available from YMC Co., Ltd.

Reversed-phase chromatography is utilized as the separation technique using each column (2.1×50 mm) under the following conditions: a mobile phase including solvent A comprising 0.1% v/v TFA in water; and solvent B comprising 250 mg insulin in 5 ml acetonitrile, 2 ml 50% glacial acetic acid and 43 ml DI water. This is diluted down 1:5 with 0.1% TFA in DI water to make the 1 mg/ml insulin solution. A gradient process is used wherein the column is equilibrated at 100% solvent A; followed by increasing from 0% up to 100% solvent B for 1 minute; holding the flow of solvent B at 100% for 200 minutes; followed by increasing from 0% up to 100% solvent A (0% solvent B) for 1 minute. The flow rate is 0.2 ml/minute. The column is run at a room temperature of 25° C. The detection is performed using a WD 170S detector (available from Dionex Corp., Sunnyvale, Calif.) at 276 nm. A Dionex HPLC system (P580 HPG high-pressure gradient, binary pump available from Dionex Corp.), Rheodyne Manual Injector (available from IDEX Corp.), and CHROMELEON® data system (available from Dionex Corp.), are also utilized in the analyses. The capacity of each material is calculated from the following equation:

$${C}_{capacity} = \frac{( [ {T}_{( at 50 \% )} - {t}_{0 ( uracil )} ] \times {C}_{Insulin} \times F )}{{V}_{Column}}$$

T_{(at 50%)}=Frontal breakthrough time was measured at 50% peak height minus 1 minute.
Cᵢₙₛᵤₗᵢₙ=1 mg/ml

### V_{Column}=0.173 ml

F (flow rate)=0.2 ml/min
t_{0uracil} came from an injection of uracil with mobile phase A at 0.2 ml/min.

The results are shown in FIG. 11, which demonstrate the increased insulin loading capacity using the silica particles of the present invention over that of conventional media. For example, the insulin loading capacity of the columns with the silica of the present invention is 154 mg/ml, while the Hydrosphere and Kromasil media provide insulin loading capacities of 133 mg/ml and 14 mg/ml, respectively, which corresponds to about 10 to about 1000% higher recovery.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

What is claimed is:

1. A porous silica particle comprising (i) an interior portion having a first elastic modulus, and (ii) a particle outer surface portion having a second elastic modulus, wherein the first elastic modulus is greater than the second elastic modulus.

2. The porous silica particle of claim 1, wherein the particle has an elastic modulus gradient with a maximum elastic modulus in an interior of the particle and a minimum elastic modulus proximate to or on an outer surface of the particle.

3. The porous silica particle of claim 1, wherein the particle has a first pore density in an interior of the particle and a second pore density proximate to or on an outer surface of the particle, the second pore density being greater than the first pore density.

4. The porous silica particle of claim 1, wherein the particle is substantially spherical.

5. The porous silica particle of claim 1, wherein the particle has an average largest particle dimension of less than about 100 μm, a pore volume of from about 0.40 cc/g to about 1.4 cc/g, an average pore diameter of from about 40 Å to about 700 Å, and a surface area of from about 200 m²/g to about 450 m²/g.

6. The porous silica particle of claim 1, wherein the particle has an average largest particle dimension of from about 3 to about 20 μm, a pore volume of from about 0.75 cc/g to about 1.1 cc/g, an average pore diameter of from about 90 Å to about 150 Å, and a surface area of about 260 m²/g to about 370 m²/g.

7. The porous silica particle of claim 6, wherein the particle has a pore volume of about 0.95 cc/g, and a surface area of about 320 m²/g.

8. The porous silica particle of claim 1, wherein the particle has an average largest particle dimension of from about 3 μm to about 20 μm.

9. A plurality of silica particles comprising at least one porous silica particle of claim 1.

10. A media for use in a chromatography column comprising at least porous one silica particle of claim 1.

11. A chromatography column in combination with at least one porous silica particle of claim 1.

12. The chromatography column of claim 11, wherein the at least one porous silica particle is positioned within the column.

13. A method of using a chromatography column, said method comprising the steps of:
processing a fluid through the chromatography column of claim 12.

14. A method of making silica particles, said method comprising the steps of:
partially hydrolyzing an organosilicate so as to form a partially hydrolyzed material;
distilling the partially hydrolyzed material to remove any ethyl alcohol and to form distilled partially hydrolyzed material;
emulsifying the distilled partially hydrolyzed material in a polar continuous phase so as to form droplets of partially hydrolyzed silicates in the polar continuous phase;
gelling the droplets via a condensation reaction with ammonium hydroxide so as to form spherical, porous particles;
washing the spherical, porous particles;
hydrothermally aging the spherical, porous particles; and
drying the spherical, porous particles to form dried porous particles.

15. The method of claim 14, further comprising separating silica particles having a first particle size from silica particles that do not having the first particle size.

16. The method of claim 15, wherein the first particle size ranges from about 3 μm to about 20 μm.

17. A method of making a chromatography column, said method comprising the steps of:
incorporating at least one silica particle formed by the method of claim 14 into the chromatography column.

18. A method of using a chromatography column, said method comprising the steps of:
processing a fluid through a chromatography column containing at least one silica particle formed by the method of claim 14.

19. The method of claim 18, wherein the fluid comprises a peptide.

20. Silica particles formed by the method of claim 14.

21. A porous silica particle comprising a plastic deformation of at least about 100 MPa.

22. A porous silica particle according to claim 21, wherein said plastic deformation is at least about 200 MPa.

23. A porous silica particle according to claim 21, wherein said plastic deformation is at least about 300 MPa.

24. A porous silica particle according to claim 21, wherein said plastic deformation is at least about 400 MPa.

25. A porous silica particle comprising a surface elastic deformation of less than 4 GPa.

26. A porous silica particle according to claim 25, wherein said elastic deformation is less than about 3 GPa.

27. A porous silica particle according to claim 25, wherein said elastic deformation is less than about 2 GPa.

28. A porous silica particle according to claim 25, wherein said elastic deformation is less than about 1 GPa.

29. A porous silica particle comprising a plastic deformation of at least about 100 MPa and an elastic deformation of less than about 4 GPa.
